(19) United States
(12) Patent Application Publication
(10) Pub. No.: US 2015/0363693 A1
(43) Pub. Date: Dec. 17, 2015

(54) ARCHITECTURE AND METHODOLOGY FOR PERFORMING REAL-TIME AUTONOMOUS ANALYTICS OVER MULTIPLE ACTUAL AND VIRTUAL DEVICES

(71) Applicant: COLDLIGHT SOLUTIONS, LLC, Wayne, PA (US)

(72) Inventors: RYAN TODD CAPLAN, Huntingdon Valley, PA (US); Bruce F. Katz, Philadelphia, PA (US); Joseph John Pizonka, Phoenixville, PA (US)

(21) Appl. No.: 14/740,863

(22) Filed: Jun. 16, 2015

Related U.S. Application Data
(60) Provisional application No. 62/012,570, filed on Jun. 16, 2014.

(51) Int. Cl. G06N 5/02

(52) U.S. Cl. CPC G06N 5/02

(57) ABSTRACT

A device for performing autonomous analytics comprises one or more adaptors, device hierarchy data, and an analytic executive. The adaptors are configured to adapt data streams from one or more heterogeneous data sources into a tagged dataset. The device hierarchy data comprises an identification of one or more hierarchical relationships between the device and one or more additional devices. The analytic executive is configured to identify a plurality of relevant devices based on the device hierarchy data and collect device data from each of the plurality of relevant devices. The analytic executive is further configured to generate a collection of analytic models using the collected device data, score one or more new data items included in the tagged dataset using the collection of analytic models, yielding scored results, and use one or more business rules to trigger an action based on the scored results.

### CROSS-REFERENCE TO RELATED APPLICATIONS

This application claims the benefit of U.S. Provisional Application Ser. No. 62/012,570 filed Jun. 16, 2014, which is incorporated herein by reference in its entirety.

### TECHNICAL FIELD

The present disclosure relates generally to methods, systems, and apparatuses, for performing real-time autonomous analytics over multiple actual and virtual devices. The disclosed methods, systems, and apparatuses may be applied to, for example, autonomously perform actions based on a set of business rules triggered based on analytic model results.

### BACKGROUND

Conventional data analytic platforms are highly dependent on humans performing certain data processing operations. For example, data may be received from a variety of homogeneous or heterogeneous data sources. This data must be extracted, transformed into a particular format or structure suitable for analysis purposes, and then loaded into a database for processing. This process, referred to as Extract-Transform-Load (ETL), requires a human intervention at multiple stages. Thus, the ETL process represents a significant bottleneck to analytic processing. An additional bottleneck exists within analytic processing itself, as human intervention may be required for the activities such as the selection of analytic models, the execution of such models, or the triggering of actions based on analytic results. Accordingly, it is desired to create an autonomous platform for receiving and processing data in a manner that allows analytics to be provided in real-time or near-real-time scenarios. Furthermore, conventional analytics treats each analysis as an isolated endeavor; as will be shown, there are considerable potential advantages to be gained by the sharing of both data and models between devices.

### SUMMARY

Embodiments of the present invention address and overcome one or more of the above shortcomings and drawbacks by providing methods, systems, and apparatuses related to performing real-time autonomous analytics over multiple actual and virtual devices.

According to some embodiments of the present invention, a device for performing autonomous analytics comprises one or more adaptors, device hierarchy data, and an analytic executive. The adaptors are configured to adapt data streams from one or more heterogeneous data sources into a tagged dataset. The device hierarchy data comprises an identification of one or more hierarchical relationships between the device and one or more additional devices. The analytic executive is configured to identify relevant devices based on the device hierarchy data and collect device data from each of those relevant devices. The analytic executive is further configured to generate a collection of analytic models using the collected device data, score one or more new data items included in the tagged dataset using the collection of analytic models, yielding scored results, and use one or more business rules to trigger an action based on the scored results.

In some embodiments, the aforementioned device also includes a display component configured to present a visualization of the scored results on a display. This visualization may comprise, for example, an augmented reality application wherein virtual objects representative of the scored results are overlaid on an image depicting one or more physical objects.

In some embodiments of the aforementioned device, the relevant devices comprise child devices hierarchically connected to the device via an ISA relationship. The analytic executive may be further configured to distribute one or more analytic models from the collection of analytic models to these child devices.

In some embodiments of the aforementioned device, the relevant devices comprise devices hierarchically connected to the device via a TYPEOF relationship. The analytic executive may be further configured to use the collected device data to identify relevant features in the tagged dataset during generation of the collection of analytic models.

In some embodiments of the aforementioned device, the relevant devices comprise devices hierarchically connected to the device via a CONTAINS relationship. The analytic executive may be further configured to identify one or more relevant data sources based on the device data collected from each of the relevant devices and connect to each of the relevant data sources. Thus, the heterogeneous data sources may comprise the one or more relevant data sources.

In some embodiments of the aforementioned device, device hierarchy data may be used to allocate processing tasks. For example, in one embodiment, the analytic executive identifies processing resources available on the one or more additional devices based on the device hierarchy data. Those processing resources are then used to generate the collection of analytic models.

According to another aspect of the present invention, as described in some embodiments, a computer-implemented method for performing autonomous analytics includes a device adapting data streams from one or more heterogeneous data sources into a tagged dataset and identifying relevant devices having a hierarchical relationship to the device. The device collects device data from each of the relevant devices and generates a collection of analytic models using the collected device data. The device scores new data items included in the tagged dataset using the collection of analytic models, yielding scored results. One or more business rules may then be used to trigger an action based on these scored results.

In some embodiments, the method may further include presenting a visualization of the scored results on a display. For example, in one embodiment, the visualization comprises one or more virtual objects representative of the scored results overlaid on an image depicting one or more physical objects.

In the aforementioned method, the relevant devices may be connected to the device via a variety of relationships in different embodiments of the present invention. For example, in some embodiments, the devices comprise child devices hierarchically connected to the device via an ISA relationship. Based on the ISA relationship, analytic models from the collection of analytic models may be distributed to the child devices. In some embodiments, the relevant devices comprise other devices hierarchically connected to the device via a TYPEOF relationship. Based on the TYPEOF relationship, the collected device data may be used to identify relevant features in the tagged dataset during generation of the collection of analytic models. In other embodiments, the relevant devices comprise other devices hierarchically connected to the device via a CONTAINS relationship. Based on the CONTAINS relationship, one or more relevant data sources may be identified based on the collected device data. A connection may then be established with each of these relevant data sources.

According to other embodiments of the present invention, a computing device for performing autonomous analytics comprises a non-volatile computer readable medium and one or more processors. The non-volatile computer readable medium is configured to store a plurality of virtual devices. Each virtual device comprises an analytic executive configured to train and score a distinct collection of analytic models based on hierarchical relationships existing between the virtual devices. The one or more processors are configured to independently execute the analytic executive associated with each respective virtual device.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 provides an example device that may serve as the fundamental unit of an AoT implementation, according to some embodiments;

FIG. 2 provides an illustration of a sample subset of the ISA hierarchy, defined by instance relations, as it may be implemented in some embodiments;

FIG. 3 illustrates the flow of information in the ISA hierarchy, according to an example embodiment;

FIG. 4 provides an example of the CONTAINS hierarchy, as it may be implemented in some embodiments;

FIG. 5 provides an example of the TYPEOF hierarchy, as it may be implemented in some embodiments;

FIG. 6 provides a possible embodiment in which a neural network model inherited from a parent node is refined on the basis of new data when retraining is indicated;

FIG. 7 provides an example application of the techniques described herein in some embodiments to predict mental wellbeing;

FIG. 8 provides an example interface for a collection of virtual sensors, as may be utilized in some embodiments; and

FIG. 9 illustrates an exemplary computing environment within which embodiments of the invention may be implemented.

### DETAILED DESCRIPTION

Systems, methods, and apparatuses are described herein which relate generally to performing real-time autonomous analytics over multiple physical and virtual devices. Such a collection of devices is commonly referred to as the Internet of Things (IoT), although the methodology described here is more general because of the inclusion of virtual devices. More specifically, techniques are described herein for configuring such devices in a software architecture which compartmentalizes analytic computations and their related data flows. This architecture, referred to herein as the “Analytics of Things” (AoT) by analogy to the IoT, may be used to achieve one or more of the following goals: understanding what has already transpired through appropriate data summary and analytic algorithms; predicting what will happen with the aid of machine learning; and influencing future actions by adjusting appropriate conditions in accord with recommendations given by the analytic system. In the AoT, unlike its traditional counterpart, each of these three goals may be realized over multiple devices and in an autonomous fashion; i.e. there is no need for direct human interaction. Analytical results are generated automatically. Moreover, actions may be initiated based on this analytic processing, if desired, without intervention.

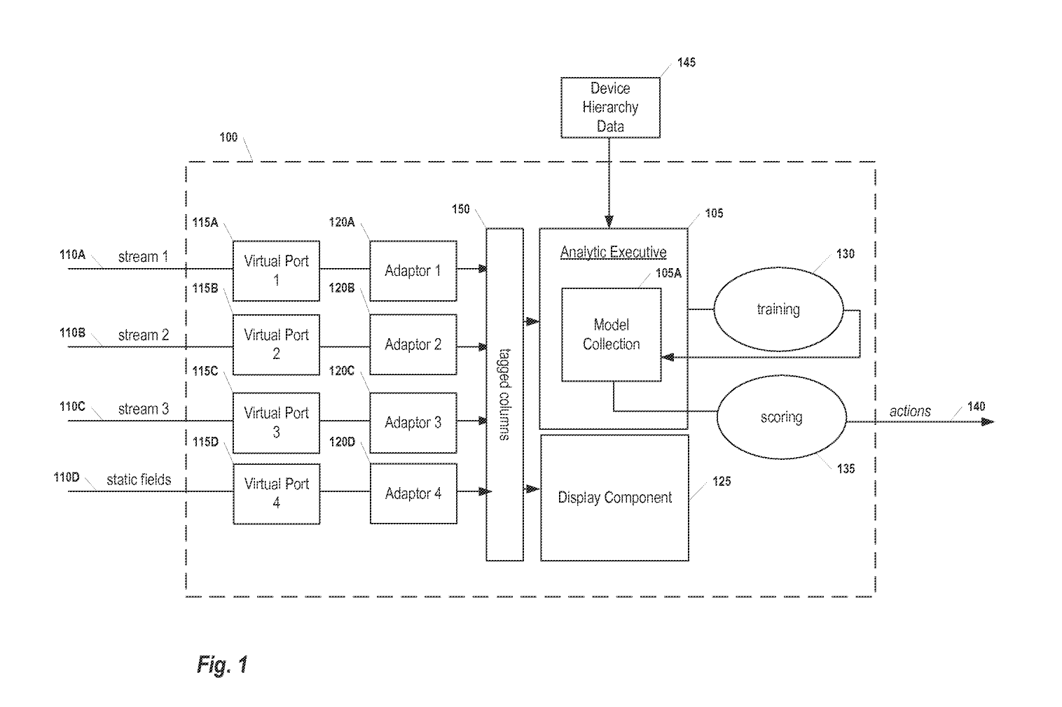

FIG. 1 provides an example Device 100 that may serve as the fundamental unit of an AoT implementation, according to some embodiments. In some embodiments, this Device 100 corresponds to an actual physical device, while in other embodiments, the Device 100 corresponds to a virtual device. An actual device in this context refers to a hardware device that provides a measurement such as, for example, temperature, pressure, rotations per second, the energy consumption, etc. Conversely, a virtual device can just be a data stream. For example, financial data (e.g., the price of a particular company's stock) may be conceived of as a stream generated by market forces but not corresponding to an actual reading from a physical device. A virtual device may also represent a general category, e.g., the notion of a general house as an abstract category as opposed to the specific house on 317 Elm Street; the utility of such abstract devices is described in more detail below. Additionally, in some embodiments, multiple devices of similar architecture to that presented in FIG. 1 may be combined to create a system of devices. This system may include only physical devices, only virtual devices, or a combination of the two device types.

All analytics in the architecture shown in FIG. 1 are inherently stream-based. Thus, time-series analysis and the associated data transformations to achieve this analysis may be achieved in a transparent fashion. In addition, predictions and associated analytics can be regenerated and improved on the basis of new information as it is produced at the device level or received over data ports. As the Device 100 is autonomous, no explicit ETL step is required. That is, there is need to gather data from disparate sources and join that data into a unified view. Streams are joined via tags, and analytics may be performed on an as-needed basis.

Data Streams 110A, 110B, and 110C comprise a series of values received from external sources (not shown in FIG. 1). These external sources may correspond to, for example, parent or child devices, or devices outside the hierarchy of the Device 100 (as explained in greater detail below). In some embodiments, the Data Streams 110A, 110B, and 110C are tagged by identifiers such as time and place. Static Fields 110D are processed in a manner similar to the Data Streams 110A, 110B, and 110C. The Static Fields 110D comprise constant attributes associated with the Device 100 that do not change over time, or change relatively slowly in case of analytically inferred properties. Virtual Ports 115A, 115B, 115C, 115D in the Device 100 allow the ingestion of external streams and/or static fields.

The Adaptors 120A, 120B, 120C, and 120D transform and join the Data Streams 110A, 110B, 110C and the Static Fields 110D into Tagged Columns 150 for processing by the Analytic Executive (AE) Component 105. Two primary issues arise in autonomous stream-based analytics, data joining and time-series analysis; each is considered here in turn. Data joining over disparate sources is in general a difficult problem, but can be made tractable assuming that each source is accompanied by a tag. The most common such tag will be a time indicator, but could also include time and position, as well as other identifying features. Once such a tag is available, two issues remain: alignment and granularity. The first issue arises because different devices will not necessarily generate data in a synchronized fashion. Therefore, some means must be present to align data to the nearest second, millisecond, or appropriate time slice. The second issue arises because differing devices may be generating at different frequencies. Therefore, if the analysis is to be carried out at the higher frequency, either the lower frequency data has to be repeated, or if carried out a lower frequency, the higher frequency data may be sampled. Likewise, joining by location may involve either repetition or sampling. For example, one stream could be by zip, and one by county.

The AE Component 105 is responsible for joining these transformed streams into a coherent view and instituting training It is also responsible for initiating scoring as well as taking these scores and transforming them into actions. The AE Component 105 also decides how often analytics should be performed, the depth of analysis, and external data sources to entertain on the basis of available computation resources. The Model Collection 105A corresponds to a number of objectives the Device 100 is trying to achieve. The Model Collection 105A may be updated autonomously and as needed, and may be initialized via inheritance from parent devices. Actions may be triggered when the values of predicted objectives meet a threshold condition. These actions can be expressed, for example, as IF-THEN rules and may have multiple antecedent conditions.

The AE Component 105 is configured to perform four tasks: initiating and carrying out model training; determining the complexity of training (e.g., number of models in an ensemble, model types, etc.) based on available resources; determining external data sources that may aid in training; and initiating scoring and triggering associated actions. Each of these tasks will now be discussed in turn.

A Training Module 130 included in the Device 100 trains the Model Collection 105A. The frequency of training initiation depends on the stationarity of the data. If the data is unchanging, then there is no need to retrain even as new data presents itself. On the other hand, if the relation between the data and a desired outcome is in constant flux, then frequent retraining is desirable. Most situations are somewhere in between, with a moderate level of retraining necessary. The simplest method of determining training frequency is to continually monitor the accuracy of predictions on the newly arrived examples with the existing model. If the error rate climbs above a preset threshold, then retraining is initiated.

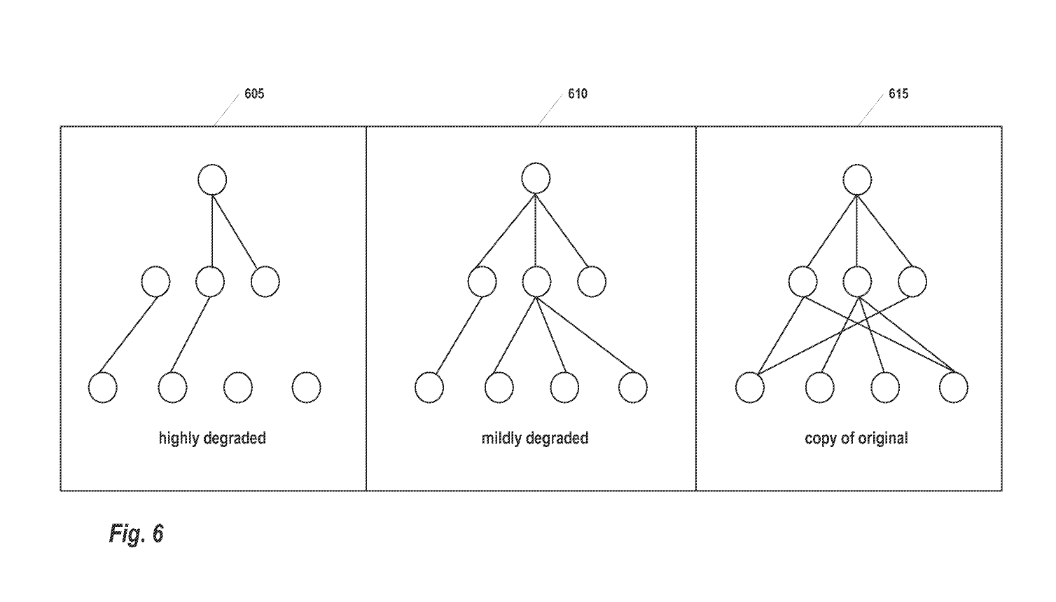

The Training Module 130 may employ various techniques generally known in the art including, for example, recurrent networks (Jordan and Elman) in the case of neural networks, as well as variations on Kalman filters. The AE also decides how to preprocess the data, such as applying wavelet transforms or other transformation functions, in order to achieve quasi-optimal results for the given data set. The size and number of windows in the past to predict the future (i.e., the “embedding dimension”), as well as the number of time steps in the future to predict may also vary across different embodiments. The latter will largely be dictated by the nature of the analysis, although it may affect the general analytic techniques. In some embodiments, a heuristic is applied such that large numbers of time steps in the future will benefit from a recurrent analysis, with this being of little use or actually detrimental for small time steps. A way of finessing the difficulties in choosing the appropriate technique, and estimating the appropriate embedding dimension, is to run many models at once; this is a common method in predictive training in general. One then runs an ensemble method on top of the many models that chooses the best subset of models, or the best subset for a given example (see also the discussion with references to FIG. 6 on ensembles). One can thus harness the computational power of multiple processors to avoid the need for human intervention at any point in the process.

The second task of the AE Component 105 involves the determination of the complexity of the training performed by the Training Module 130. This determination, in turn, is a function of the number of examples to train, the size of each example (number of feature columns), and the available resources for the given training task. Rather than attempting to explicitly solve this difficult problem, a meta-learner (not shown in FIG. 1) may be directed to provide an estimate of the solution based on past experience with learning in this device. The meta-learner will then provide heuristic advice to the executive and allow the maximally complex training regime consistent with time and resource constraints.

The third task of the AE Component 105 is to suggest external data sources that will improve analysis. For example, weather data may be found to influence mood and wellbeing for most people. Therefore, it was incorporated in the analytics for the Device 100. However, given the wide range of data that could potentially influence a given outcome, and given the possibility of spurious correlations, the question remains as to how to determine that a variable such as the weather is relevant in the first place. Again, an optimal solution to this problem is likely intractable, but an adaptive system could in principle generate a heuristic solution. Such a system would attempt to join data sources at random at first. By noting which joins are successful, as measured either by increases in the mutual information between the joined source and the outcome, improved training, or both, and which ones fails, it could develop a model of the joining process. Note that these heuristics would also be inheritable. For example, learning taking place in the Device 100 could initially draw on heuristics for the general PERSON device, but become refined with further training.

Regarding the fourth task of the AE Component 105 is initiating scoring and triggering associated actions, the AE Component 105, a Scoring Engine 135 applies the models in the Model Collection 105A to data received via the data streams 110A, 110B, and 110C to produce scores (i.e., outputs of the model). The Scoring Module 135 then transforms these scores into one or more Actions 140 based on, for example, a set of predetermined business rules (e.g., IF-THEN rules). Because Actions 140 are triggered by goal states, and because such states are predictions of the system, actions can be taken in advance of actual events and may alleviate or alter the state of these events before they occur.

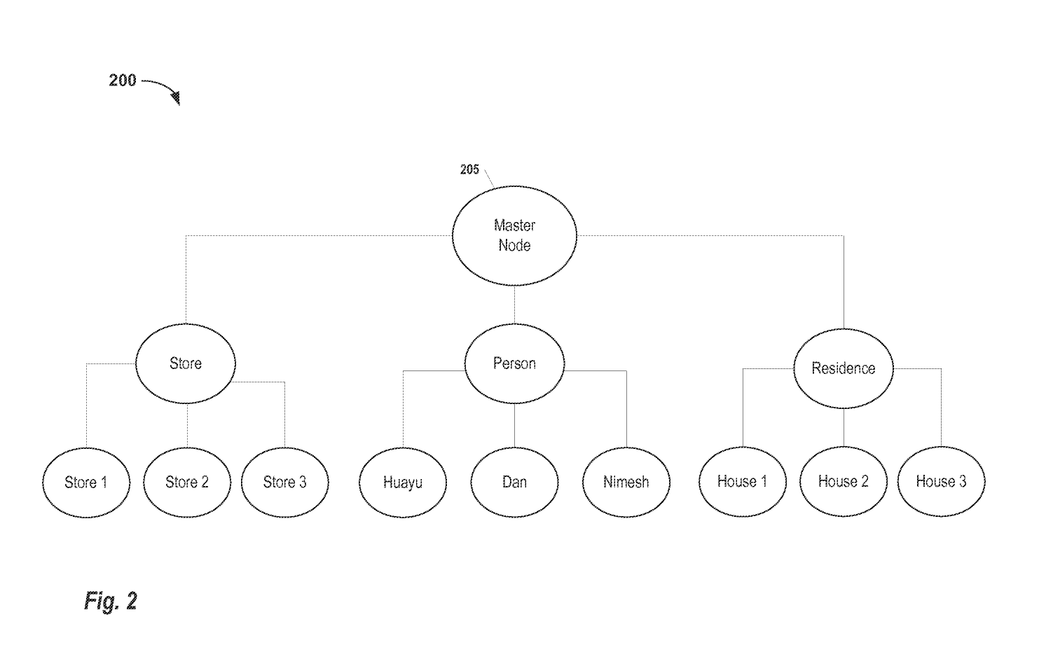

The AE Component 105 draws upon Device Hierarchy Data 145 for device contextual information and to make decisions for model generation and training Different hierarchy types may be used to define the relationships between devices such as the Device 100 shown in FIG. 1. These hierarchy types are described in detail below with reference to FIGS. 2, 4, and 5. Briefly, one or more of three hierarchies may be utilized. The ISA hierarchy defines instances of higher-order classes (e.g., Felix ISA cat). This hierarchy is used for the creation of associated higher-order models via the upward propagation of data, and the inheritance of such models downward. The CONTAINS hierarchy defines physical containment and by implication utility to this device (e.g., the house at 317 Elm St. CONTAINS a smart thermostat). The CONTAINS hierarchy is used to route streams to the containing device by default. The TYPEOF hierarchy defines subtype relations; (e.g., temperature is a TYPEOF weather measurement). This hierarchy is used for determination of possible set of streams relevant to a given model. Distance in the TYPEOF hierarchy is an approximate heuristic of utility. Various ontological frameworks generally known in the art may be used for storing Device Hierarchy Data 145. For example, in some embodiments, a standard ontology language (e.g., RDF, OWL as standardized by W3C) is used to store the Device Hierarchy Data 145 in one of more data files.

Prior to information being generated at a given level of the Device Hierarchy Data 145, the AE Component 105 may inherit more general analytic models in order to make initial judgments before refinement based on this later information. Information can optionally flow upward to inform models at higher level of the Device Hierarchy Data 145. This information allows the creation of superordinate models, which may be inherited later by new subordinate devices. A key problem in model inheritance is to blend the knowledge of the superordinate model with the subordinate model in a seamless and efficient manner. For example, suppose that one has a general model that predicts heart arrhythmia. One does not want to start from scratch when building a model of an individual's cardiac irregularities; this would ignore that accumulated knowledge implicit in the general model. On the other hand, to use only the general model would mean that the model would not be tailored to the idiosyncrasies of the patient. One advantage of the techniques described herein is that one does not have to decide in advance how much of the general model to use and how much to discard. Rather, one can use multiple models with varying degrees of degradation and an ensemble methodology to blend the results of these models.

It should be noted that the Device Hierarchy Data 145 provides several benefits in terms of security. Because data is encapsulated at the device level, it can optionally be marked as non-public and not propagated either upward or downward in the Device Hierarchy Data 145. This protects sensitive data from leaving the native device, and also provides a means of making data opaque to other devices in order to simplify their analyses.

The Display Component 125 includes a collection of methods for the display and visualization of the Data Streams 110A, 110B, 110C and the Static Fields 110D, and the results of analytic processes performed by the AE Component 105. As with the models in the Model Collection 105A, methods applied by the Display Component 125 may be inherited or they may be tailored to the particular device. In some embodiments, visualization for the display of stream data as well as analytic results may be inherited to start from a master node in the Device Hierarchy Data 145. As in all object-oriented methodologies, however, this can be overridden and device-specific visualization can be provided if desired.

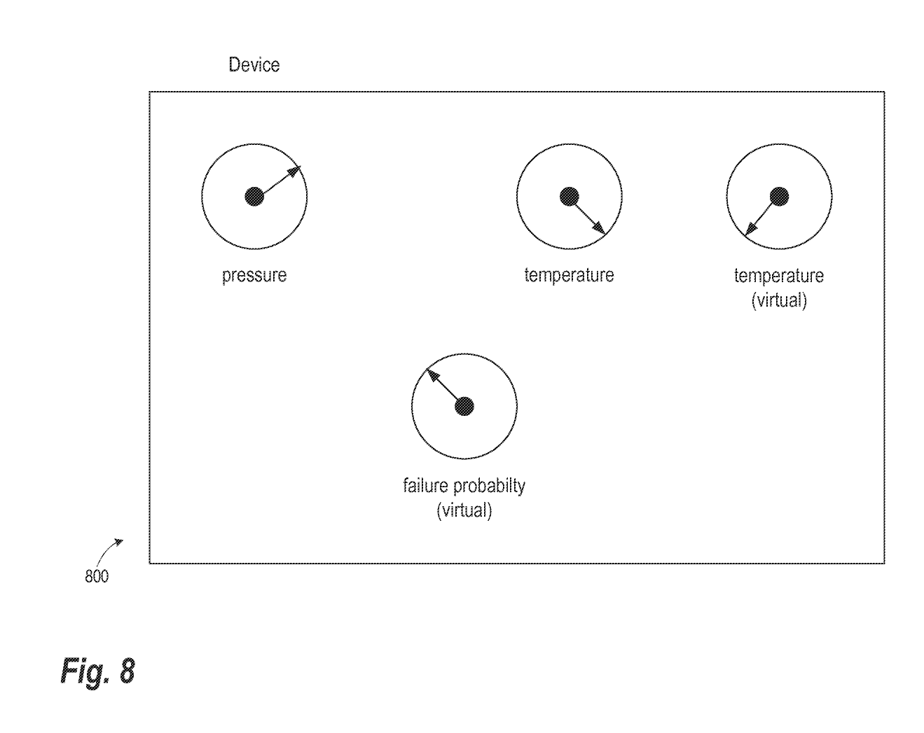

In some embodiments, the Display Component 125 may utilize one or more augmented reality techniques to enhance visual presentation of analytic results. As is understood in the art, augmented reality is the overlaying of a photo or real-time object with external indicators or annotations. In the context of a device, the most natural such overlay will be sensor values. Thus, when viewing the device via a tablet or other computational device, not only is the actual physical object seen, but also some indication of the sensor value, such as a gauge or other measurement graphic. AoT offers the opportunity of adding to these augmented devices with what may be termed virtual sensors; i.e., graphics that indicate not only the actual values of physical quantities within the device, but quantities inferred from predictive models. This is illustrated in FIG. 8 in the case of a hypothetical device 800 with two augmented sensors, temperature and pressure. In addition to these actual sensor values, two virtual sensors are also shown in FIG. 8, corresponding to the two sorts of predictions that could be made. In the first case, the analytic quantity is the future value of an existing sensor, temperature. Thus, the photo could also be overlaid with a graph showing not only the predicted value at some fixed future time, but also the predicted time course of these values. The second type of virtual quantity is a new feature not directly measuring a quantity within the device. For example, the probability of device failure is shown in this example. This quantity may also be derived from a predictive model by training on prior failure instances or inheriting and refining such a model from a higher order node in the ISA hierarchy in the normal fashion described above.

There are a number of benefits to an architecture based on the Device 100 shown in FIG. 1. First, the architecture is autonomous. The AE Component 105 decides when and how analytics are carried out. There is thus no need for human intervention to initiate the construction of models; they are reformulated on a continuous basis as new data become available. Additionally, two type of relevance filtering are made possible via this architecture, standard feature filtering based on information-theoretic measure or the like, and with the aid of the TYPEOF hierarchy, adaptive filtering over collections of features. Each of these types of filtering may be applied alone or in combination in different embodiments.

FIG. 2 provides an illustration of a sample subset of the ISA hierarchy 200, defined by instance relations, as it may be implemented in some embodiments. In the ISA relationship, a child node is an instance of its parent node; for example House 2 is an instance of Residence. Master Node 205 is the parent device at the top of the ISA hierarchy 200. The purpose of the ISA hierarchy is to provide models as devices come online and before sufficient data exists in the child node, as described next.

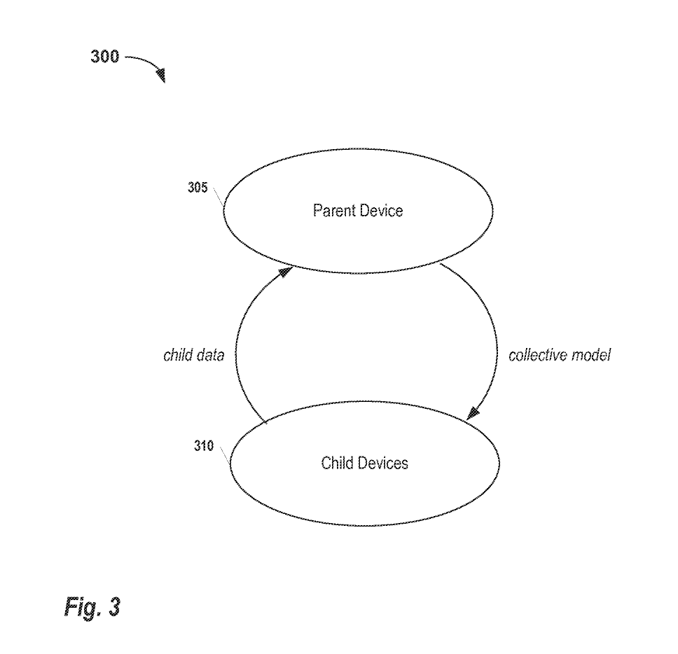

FIG. 3 illustrates the flow of information in the ISA hierarchy. Data flows upwards from child devices to parent nodes; this federated data is then used to form a general model at this node. Models flow down from parent devices to child devices in the case the child device is lacking a model (such as when the device initiates).

For example, suppose one is attempting to predict blood pressure. The parent device 305 in this case is all people (a virtual device), and the child devices 310 are the individual patients. Data from these patients flow to the parent node, and this collective data is used to construct a general model based on this data. This collective model then flows down towards individual patients, and can be used to score (i.e., estimate blood pressure) for a new patient before any particular information is available. This model, at the child level, can then be refined as new data comes in for this patient, in the manner described in the section on model inheritance.

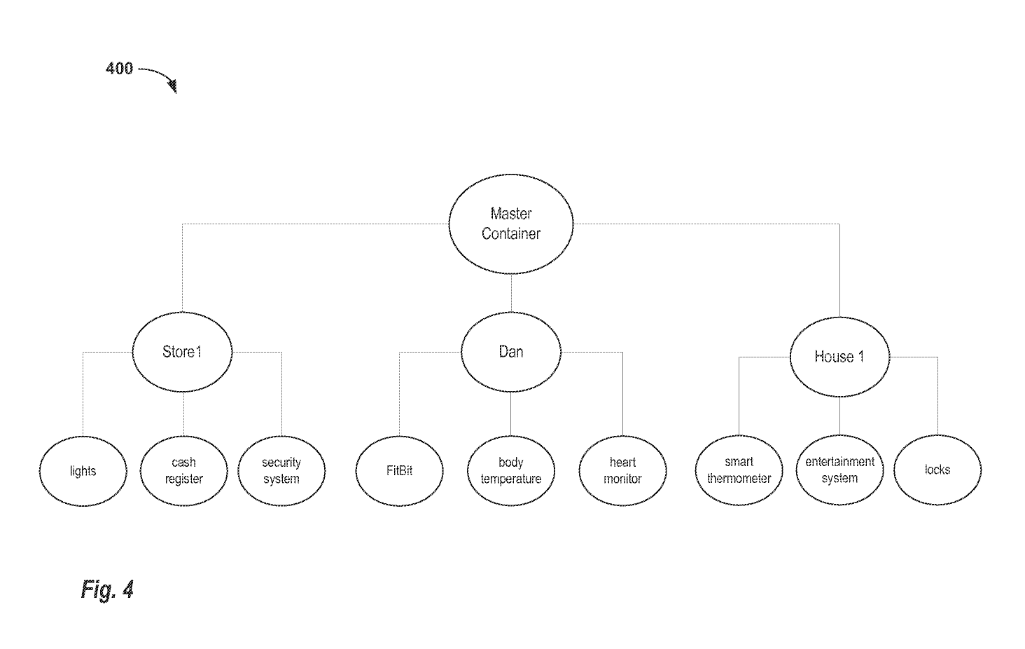

FIG. 4 provides an example of the CONTAINS hierarchy 400, as it may be implemented in some embodiments. Unlike the ISA hierarchy (see FIG. 2), the CONTAINS hierarchy 400 is not a conceptual set of relations but a physical one. The implicit heuristic is that containment, or at the least physical proximity implies that the data streams from such a device are potentially relevant to the superordinate container. As such, by default and unless explicitly blocked, the system will open ports to such streams and allow them as potential independent features that will affect results at the superordinate device level. For example, if a person is wearing a set of devices, it is presumed that streams from these devices may affect the values of other streams, or inferred more abstract quantities such as mood and physical wellbeing.

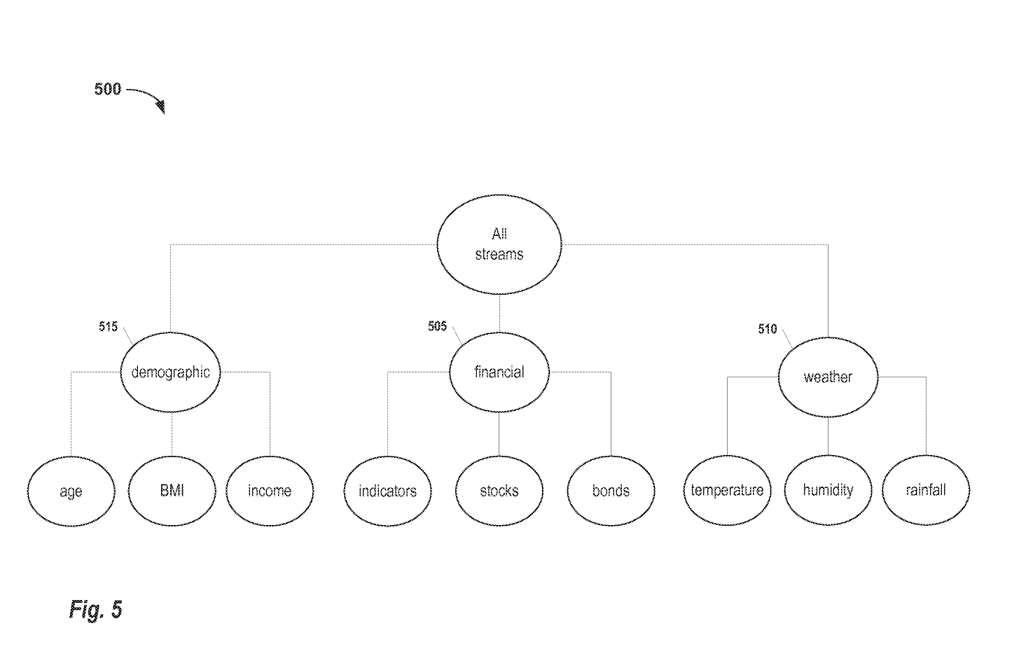

FIG. 5 provides an example of the TYPEOF hierarchy 500, as it may be implemented in some embodiments. The TYPEOF hierarchy is a conceptual organization of streams by category. In FIG. 5, showing a small sample of a much larger “tree of knowledge”, there are three stream types, financial 505, weather 510, and demographic 515. The primary purpose of the TYPEOF hierarchy 500 is to provide the analytic executive with a notion of the organization of data sources in order to determine relevance. For example, if an analytic executive finds that temperature is relevant in determining mood, it will be more likely to attempt to show that humidity is also a determining feature for this quantity in future training sessions. On the basis of this information alone, and given the same amount of analytical resources, it would not however attempt to show that bond prices have a similar effect, and these would be excluded in order to improve model accuracy and analysis time. Thus, the TYPEOF hierarchy 500 operates as a kind of relevance filter over collections of features, with the operating assumption being that distance in the hierarchy corresponds to distance in relevance. This assumption is easily generalized to more complete hierarchies (with more branches per node and more levels of granularity) than the one shown in FIG. 6.

Streams within the TYPEOF hierarchy are not limited to structured data (i.e., as time-tagged feature-value pairs). It is also possible and in many cases desirable that unstructured data be drawn upon to improve predictive accuracy. Unstructured data includes any text-based source such as online news sources, social media, blogs, and other more general text feeds; however, whatever form these sources derive from, they must be time-tagged in order to be joined with structured sources. Once this is accomplished, conversion to structured data may be carried out in accord with a number of transformation techniques in the art including but not limited to topic extraction, sentiment analysis, speaker identification, and the like.

As an example, consider the prior mood prediction example. Dan (the target device) may be affected not only by easily quantifiable objects such as the weather or by his physical activity but also general sentiment found in the news. He may care deeply, for example, about progress in the Middle East or another region of the world. Barring an externally-computed index for such a feature, it is not possible to directly incorporate this into his mood model. However, it would be possible to mine text for sentiment towards this region, convert this into a time-tagged stream, and then proceed in the normal fashion in using this source as a predictor for his mood.

FIG. 6 provides a possible embodiment in which a neural network model inherited from a parent node is refined on the basis of new data when retraining is indicated. In FIG. 6, the newly acquired examples are applied to three models in unison, one highly degraded from the original, general model, one with intermediate amounts of degradation, and one identical copy of the original model. The leftmost model 605 will work best when the new data does not resemble the data on which the general model was obtained, with the opposite true for the rightmost model 615; the middle model 610 is an intermediate case. In some embodiments, an ensemble algorithm will choose the best performing of the new models, while in other embodiments, the results of the models are blended. These embodiments include a vote strategy, in which the models' outputs are averaged, a meta-learning strategy, in which the ensemble picks the best model for each example, and a standard boost strategy, in which models are weighted by the ability to account for the examples. Regardless of the chosen ensemble strategy, the proposed method allows for the autonomous incorporation of new data into an existing model without the need to decide the divergence between the current particular case and the more general case.

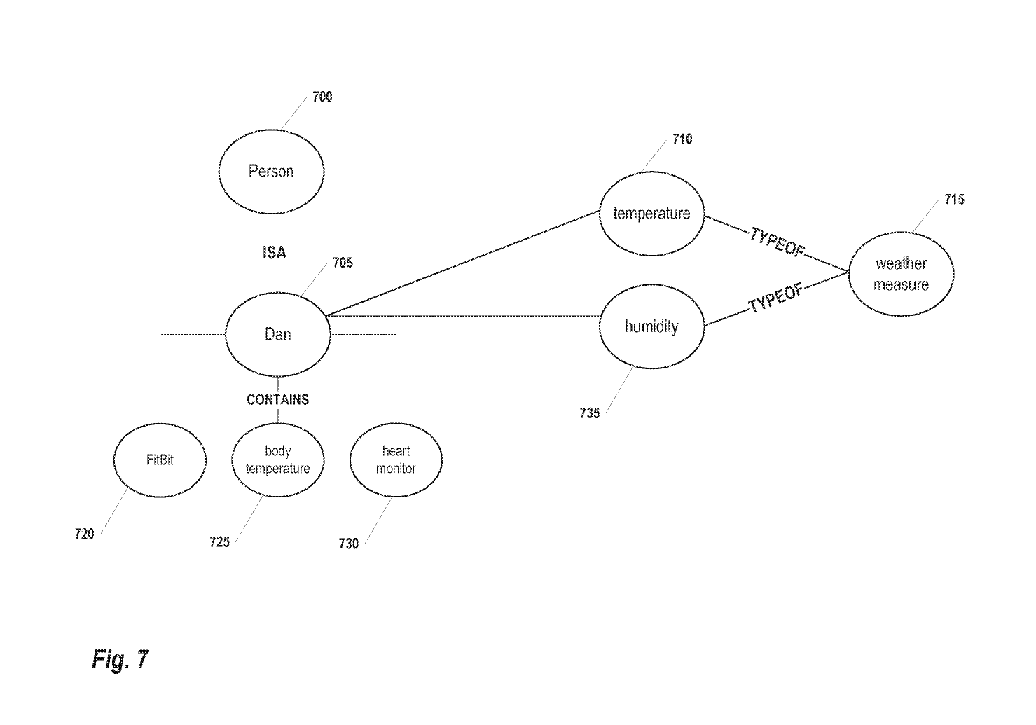

FIG. 7 provides an example application of the techniques described herein in some embodiments to predict mental wellbeing. As with all analytics, the goal is to understand unusual states, both positive and negative, to predict those states, and to make recommendations so as to optimize the goal state. FIG. 7 shows the devices in question pertinent to the device Dan 705 (in this case a person). Dan 705 receives streams from 5 devices. Three are derived directly from the CONTAINS hierarchy, and include a Fitbit™ 720, a body thermometer 725, and a heart monitor 730. Dan also receives two time and place tagged pieces of weather information: temperature 710 and humidity 735 (each a TYPEOF a weather measure 715). The AE of Dan 705 initially finds that temperature is affecting Dan's mood, and decides to test whether humidity, a closely related virtual device in the TYPEOF hierarchy, also has an effect. After finding that this indeed improves predictive accuracy, it includes humidity in future models.

Dan 705 initially inherits a general model of wellbeing from the PERSON virtual device 700, his immediate parent in the ISA hierarchy. However, it finds that the general model does not fit Dan's case well. For example, Dan 705 becomes especially anxious when the temperature begins to drop in the autumn. The model adjusts to this case, and a new model that more closely fits the temperament of Dan 705 eventually supplants the original inherited model. Dan 705 may also allow the information regarding his mental and other states to flow upward to the PERSON virtual device 700. This information helps build better models at this level, for future inheritance by other people.

The model may also contain conditions that trigger certain actions (not shown). For example, if it sees that Dan 705 is becoming especially anxious, a warning is sent to Dan's email. In addition, if it detects a state of relatively long-lived low-level anxiety, it can make the recommendation that Dan 705 should go to the gym, if past experience has shown that this elevates his mood. Note that as in all cases with the proposed architecture, the models generated are both autonomous and dynamic. Once the initial structure has been specified, the system as a whole works to optimize mood for Dan 705, without the need for further intervention.

In some embodiments, the techniques described herein may be combined with deep learning techniques generally known in the art. Deep learning is the branch of predictive analytics that transforms large features sets with relatively low intrinsic information regarding a category or prediction into a viable adaptive model. The paradigmatic case of deep learning is from visual scenes into one or more categories that describe the nature of that scene. Note that the application of standard machine learning techniques directly to the pixels in the image is unlikely to yield anything of interest; invariant properties of the scene exist not at this level but at transformation of sets of pixels into sub-categories that are independent of specific realizations. Moreover, the types of transformations that should be made for a particular problem can themselves be learned. The entire set of transformations, from raw pixel values, to parts describing sets of pixels, to categories is then the final result of this type of learning model.

The application of deep learning to the AoT is straightforward. Imagine a device augmented by a camera or set of cameras focusing on some aspect of this device. The set of images or the video sequence itself may be indicative of some future action. As an example, consider a gear that is slowly decaying. It may be impractical to attach multiple sensors on each cog in the gear, and moreover, the failure of that gear may be the result of multiple micro-failures on the edge or in the center of that part. Visual inspection in the context of a deep learning model may be able, in contrast, to yield a decay score for the gear, which then can be augmented by other sensor information or other deep learning analytics to produce an overall decay score for the device as a whole.

Although the above presents a general model of the transfer of both data and models in the context of a set of related devices, special hardware-based challenges may be present depending on the nature of the devices and their physical proximity. In particular, in many cases the ISA hierarchy will be over a geographically diffuse set of devices. For example, in a manufacturing environment, similar device types (e.g., an industrial printer of a particular type) will be located in numerous locations throughout the world. It would be impractical to connect such devices directly. The natural solution in these instances is to form a hub in the cloud to instantiate the concept of an abstract printer of this type, and funnel information to this virtual device. Predictive models will then be formed at this hub, and then transmitted back to new devices of this type as they come online.

The set of computational units located on edge devices (e.g., the temperature sensors, appliances, etc.) represents a considerable resource that can be drawn upon for any of the time-intensive algorithms described above. The collection of edge devices available for computational work is referred to herein as the “mist,” by analogy with computing in the cloud, and indicating both the diffuse and grounded nature of these resources relative to the typical cloud formation. In some embodiments, the analytic techniques may be executed in a distributed manner using the various computing resources in the mist.

For example, ensemble predictive models by definition are constructed from a set of non-interacting models before the results of such are joined by averaging techniques and the like to produce a unified model. As such, this operation can easily be parallelized, with each model running in a unique mist device. Furthermore, training is relatively infrequent; thus, at any given time, each mist device, though typically weaker in compute-power than its computationally richer cousins in the cloud, has at least some free computational cycles to draw upon. Finally, many model types from which ensembles are constructed are relatively simple (such as decision tree stumps), and thus are computationally demanding in the collective sense but not by ensemble component.

These sets of conditions make the mist a viable distributed computing environment, and in many cases, parallelization across the mist will be able to achieve results comparable to more conventional analytic environments. Furthermore, such a sharing scheme can be implemented without the need for an explicit hub or supervising master node. One method is for individual devices to send out requests for external training to other devices open to such requests. If busy, the external device declines; however, if free the device requests the data from the original sender, and then provides a predictive model when complete. The sender is now “in debt” to the receiver, and thus implicitly agrees to provide a training environment sometime in the future for the receiver. Other more complex bookkeeping schemes are possible, but all work by leveraging the considerable collective computational resources that lie fallow much of the time.

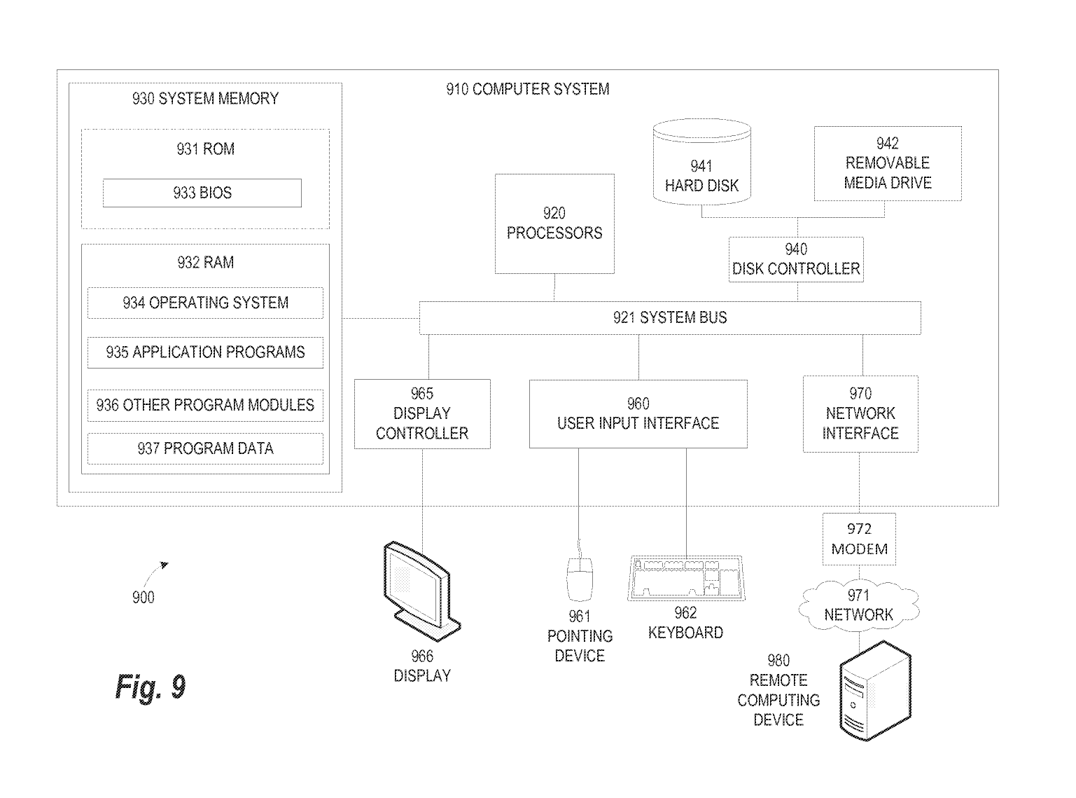

As an alternative (or addition) to computation in the mist, the techniques described herein may be applied on a computing device such as illustrated in FIG. 9 in some embodiments. Computers and computing environments, such as computer system 910 and computing environment 900, are known to those of skill in the art and thus are described briefly here.

As shown in FIG. 9, the computer system 910 may include a communication mechanism such as a system bus 921 or other communication mechanism for communicating information within the computer system 910. The computer system 910 further includes one or more processors 920 coupled with the system bus 921 for processing the information.

The processors 920 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 9, the computer system 910 also includes a system memory 930 coupled to the system bus 921 for storing information and instructions to be executed by processors 920. The system memory 930 may include computer readable storage media in the form of volatile and/or nonvolatile memory, such as read only memory (ROM) 931 and/or random access memory (RAM) 932. The RAM 932 may include other dynamic storage device(s) (e.g., dynamic RAM, static RAM, and synchronous DRAM). The ROM 931 may include other static storage device(s) (e.g., programmable ROM, erasable PROM, and electrically erasable PROM). In addition, the system memory 930 may be used for storing temporary variables or other intermediate information during the execution of instructions by the processors 920. A basic input/output system 933 (BIOS) containing the basic routines that help to transfer information between elements within computer system 910, such as during start-up, may be stored in the ROM 931. RAM 932 may contain data and/or program modules that are immediately accessible to and/or presently being operated on by the processors 920. System memory 930 may additionally include, for example, operating system 934, application programs 935, other program modules 936 and program data 937.

The computer system 910 also includes a disk controller 940 coupled to the system bus 921 to control one or more storage devices for storing information and instructions, such as a magnetic hard disk 941 and a removable media drive 942 (e.g., floppy disk drive, compact disc drive, tape drive, and/or solid state drive). Storage devices may be added to the computer system 910 using an appropriate device interface (e.g., a small computer system interface (SCSI), integrated device electronics (IDE), Universal Serial Bus (USB), or FireWire).

The computer system 910 may also include a display controller 965 coupled to the system bus 921 to control a display or monitor 966, such as a cathode ray tube (CRT) or liquid crystal display (LCD), for displaying information to a computer user. The computer system includes an input interface 960 and one or more input devices, such as a keyboard 962 and a pointing device 961, for interacting with a computer user and providing information to the processors 920. The pointing device 961, for example, may be a mouse, a light pen, a trackball, or a pointing stick for communicating direction information and command selections to the processors 920 and for controlling cursor movement on the display 966. The display 966 may provide a touch screen interface that allows input to supplement or replace the communication of direction information and command selections by the pointing device 961.

The computer system 910 may perform a portion or all of the processing steps of embodiments of the invention in response to the processors 920 executing one or more sequences of one or more instructions contained in a memory, such as the system memory 930. Such instructions may be read into the system memory 930 from another computer readable medium, such as a magnetic hard disk 941 or a removable media drive 942. The magnetic hard disk 941 may contain one or more datastores and data files used by embodiments of the present invention. Datastore contents and data files may be encrypted to improve security. The processors 920 may also be employed in a multi-processing arrangement to execute the one or more sequences of instructions contained in system memory 930. In alternative embodiments, hard-wired circuitry may be used in place of or in combination with software instructions. Thus, embodiments are not limited to any specific combination of hardware circuitry and software.

As stated above, the computer system 910 may include at least one computer readable medium or memory for holding instructions programmed according to embodiments of the invention and for containing data structures, tables, records, or other data described herein. The term “computer readable medium” as used herein refers to any medium that participates in providing instructions to the processors 920 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 941 or removable media drive 942. Non-limiting examples of volatile media include dynamic memory, such as system memory 930. Non-limiting examples of transmission media include coaxial cables, copper wire, and fiber optics, including the wires that make up the system bus 921. Transmission media may also take the form of acoustic or light waves, such as those generated during radio wave and infrared data communications.

The computing environment 900 may further include the computer system 910 operating in a networked environment using logical connections to one or more remote computers, such as remote computing device 980. Remote computing device 980 may be a personal computer (laptop or desktop), a mobile device, a server, a router, a network PC, a peer device or other common network node, and typically includes many or all of the elements described above relative to computer system 910. When used in a networking environment, computer system 910 may include modem 972 for establishing communications over a network 971, such as the Internet. Modem 972 may be connected to system bus 921 via user network interface 970, or via another appropriate mechanism.

Network 971 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 910 and other computers (e.g., remote computing device 980). The network 971 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 971.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A device for performing autonomous analytics, the device comprising:
one or more adaptors configured to adapt data streams from one or more heterogeneous data sources into a tagged dataset;
device hierarchy data comprising an identification of one or more hierarchical relationships between the device and one or more additional devices;
an analytic executive configured to:
identifying a plurality of relevant devices based on the device hierarchy data,
collecting device data from each of the plurality of relevant devices,
generating a collection of analytic models using the collected device data,
scoring one or more new data items included in the tagged dataset using the collection of analytic models, yielding scored results, and
using one or more business rules to trigger an action based on the scored results.

2. The device of claim 1, further comprising:
a display component configured to present a visualization of the scored results on a display.

3. The device of claim 2, wherein the visualization comprises one or more virtual objects representative of the scored results overlaid on an image depicting one or more physical objects.

4. The device of claim 1, wherein the plurality of relevant devices comprises a plurality of child devices hierarchically connected to the device via an ISA relationship.

5. The device of claim 4, wherein the analytic executive is further configured to:
distribute one or more analytic models from the collection of analytic models to the plurality of child devices.

6. The device of claim 1, wherein the plurality of relevant devices comprises a plurality of devices hierarchically connected to the device via a TYPEOF relationship.

7. The device of claim 6, wherein the analytic executive is further configured to:
use the collected device data to identify relevant features in the tagged dataset during generation of the collection of analytic models.

8. The device of claim 1, wherein the plurality of relevant devices comprises a plurality of devices hierarchically connected to the device via a CONTAINS relationship.

9. The device of claim 8, wherein the analytic executive is further configured to:
identify one or more relevant data sources based on the device data collected from each of the plurality of relevant devices;
connect to each of the one or more relevant data sources,
wherein the one or more heterogeneous data sources comprise the one or more relevant data sources.

10. The device of claim 1, wherein the analytic executive is further configured to:
identifying one or more processing resources available on the one or more additional devices based on the device hierarchy data;
using the one or more processing resources to generate the collection of analytic models.

11. A computer-implemented method for performing autonomous analytics, the method comprising:
adapting, by a device, a plurality of data streams from one or more heterogeneous data sources into a tagged dataset;
identifying, by the device, a plurality of relevant devices having a hierarchical relationship to the device;
collecting, by the device, device data from each of the plurality of relevant devices,
generating, by the device, a collection of analytic models using the collected device data,
scoring, by the device, one or more new data items included in the tagged dataset using the collection of analytic models, yielding scored results, and
using one or more business rules to trigger an action based on the scored results.

12. The method of claim 11, further comprising:
presenting a visualization of the scored results on a display.

13. The method of claim 12, wherein the visualization comprises one or more virtual objects representative of the scored results overlaid on an image depicting one or more physical objects.

14. The method of claim 11, wherein the plurality of relevant devices comprises a plurality of child devices hierarchically connected to the device via an ISA relationship.

15. The method of claim 14, further comprising:
distributing one or more analytic models from the collection of analytic models to the plurality of child devices.

16. The method of claim 11, wherein the plurality of relevant devices comprises a plurality of devices hierarchically connected to the device via a TYPEOF relationship.

17. The method of claim 16, further comprising:
using the collected device data to identify relevant features in the tagged dataset during generation of the collection of analytic models.

18. The method of claim 11, wherein the plurality of relevant devices comprise a plurality of devices hierarchically connected to the device via a CONTAINS relationship.

19. The method of claim 18, further comprising:
identifying one or more relevant data sources based on the device data collected from each of the plurality of relevant devices;
connecting to each of the one or more relevant data sources,
wherein the one or more heterogeneous data sources comprise the one or more relevant data sources.

20. A computing device for performing autonomous analytics, the computing device comprising:
a non-volatile computer readable medium configured to store a plurality of virtual devices, each virtual device comprising:
an analytic executive configured to train and score a distinct collection of analytic models based on hierarchical relationships existing between the plurality of virtual devices; and
one or more processors configured to independently execute the analytic executive associated with each respective virtual device.
